(19) United States
(12) Patent Application Publication
(10) Pub. No.: US 2016/0183004 A1
(43) Pub. Date: Jun. 23, 2016

(54) REED FOR A RECEIVER AND METHOD OF METHOD OF MANUFACTURING THE SAME

(71) Applicant: Knowles Electronics, LLC, Itasca, IL (US)

(72) Inventors: Mekell Jiles, Flossmoor, IL (US); Steve Anderson, Itasca, IL (US); Thomas Miller, Arlington Heights, IL (US)

(21) Appl. No.: 14/950,514

(22) Filed: Nov. 24, 2015

Related U.S. Application Data
(60) Provisional application No. 62/093,831, filed on Dec. 18, 2014.

(51) Int. Cl. H04R 11/02

(52) U.S. Cl. CPC H04R 11/02; H04R 2209/041

(57) ABSTRACT

An apparatus includes a first armature and a second armature, wherein the first armature and the second armature are coupled together in a common connection region; a coil, wherein at least a portion of the common connection region extends through the coil, the coil extending around a horizontal axis; one or more magnets; a drive rod coupled to the common connection region; and a diaphragm coupled to the drive rod; wherein electrical excitation of the coil causes the common connection region to move in a vertical direction orthogonal to the horizontal axis and not along the horizontal axis.

### CROSS-REFERENCE TO RELATED APPLICATION

This application claims the benefit of U.S. Provisional Patent Application Ser. No. 62/093,831, filed Dec. 18, 2014, entitled REED FOR A RECEIVER AND METHOD OF METHOD OF MANUFACTURING THE SAME which is incorporated by reference in its entirety herein.

### FIELD OF THE INVENTION

This application relates to receivers and, more specifically, to reeds (or armatures) used in these devices.

### BACKGROUND OF THE INVENTION

Receivers are used in many of today's electronic devices. A receiver converts electrical signals representing voice into acoustic energy that is presented for listening to a user. For example, receivers can be used in hearing instruments, personal computers, cellular phones to mention a few examples.

The receiver typically includes several components. For example, these components usually include a coil, a stack, magnets, and a reed (or armature). The reed is connected to a diaphragm. Electrical current (representing sound) excites the coil, creating a magnetic field/flux together with the magnets, and this moves the reed. Since the reed is connected with the diaphragm, as the reed moves the diaphragm and displaces air, thereby creating sound.

There have been some problems with these previous approaches. The desired movement of the diaphragm is in an up-down direction. Unfortunately, in many previous designs, the reed also moves in the horizontal direction. This horizontal movement creates several problems including distortion of the signal. Another problem (when the receiver is used in a hearing aid) is reducing the gain before feedback in the hearing aid due to excessive axial vibration.

Previous attempts at solving this problem have been unsuccessful. This has resulted in some user dissatisfaction with these previous approaches.

### BRIEF DESCRIPTION OF THE DRAWINGS

For a more complete understanding of the disclosure, reference should be made to the following detailed description and accompanying drawings wherein:

FIG. 1 comprises a perspective view of a receiver module according to various embodiments of the present invention;

FIG. 2 comprises a side view of the receiver of FIG. 1 taken along line A-A according to various embodiments of the present invention;

FIG. 3 comprises an end view of the receiver of FIG. 1 and FIG. 2 according to various embodiments of the present invention;

FIG. 4 comprises an end view cross section of an armature as used in the examples of FIG. 1, FIG. 2, and FIG. 3 according to various embodiments of the present invention;

FIG. 5 comprises a side view of one example of a reed according to various embodiments of the present invention;

FIG. 6 comprises a flow chart of one approach of manufacturing the reed assembly (and receiver) according to various aspects of the present invention;

FIG. 7 comprises a perspective view of another example of a reed according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

The present approaches provide a reed that is formed and connected to the receiver in such a way so as to reduce or eliminate reed movement in the horizontal direction. This significant reduction or elimination of reed movement in the horizontal (axial) direction reduces distortion of the receiver thereby improving receiver performance. In other words, axial vibrations are reduced or eliminated. In another advantage, the side portions of the reed can be constructed with thinner dimensions thereby reducing stiffness in these portions. This may allow and facilitate the construction shorter motor structures in one advantage.

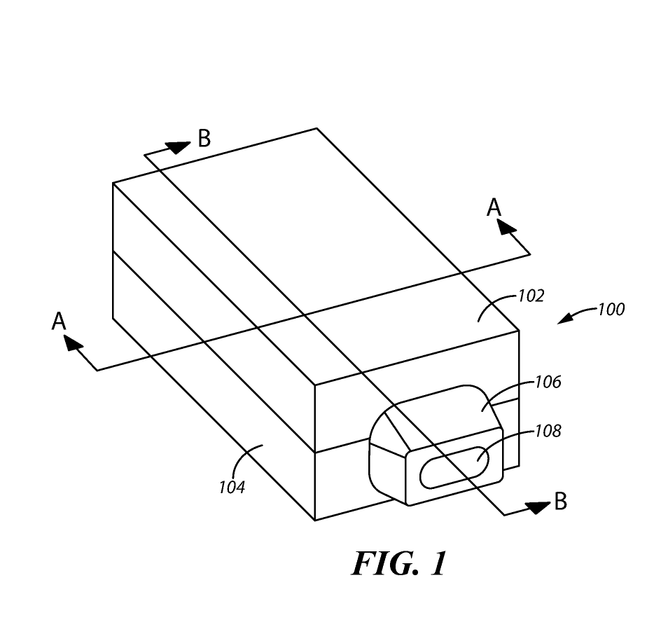

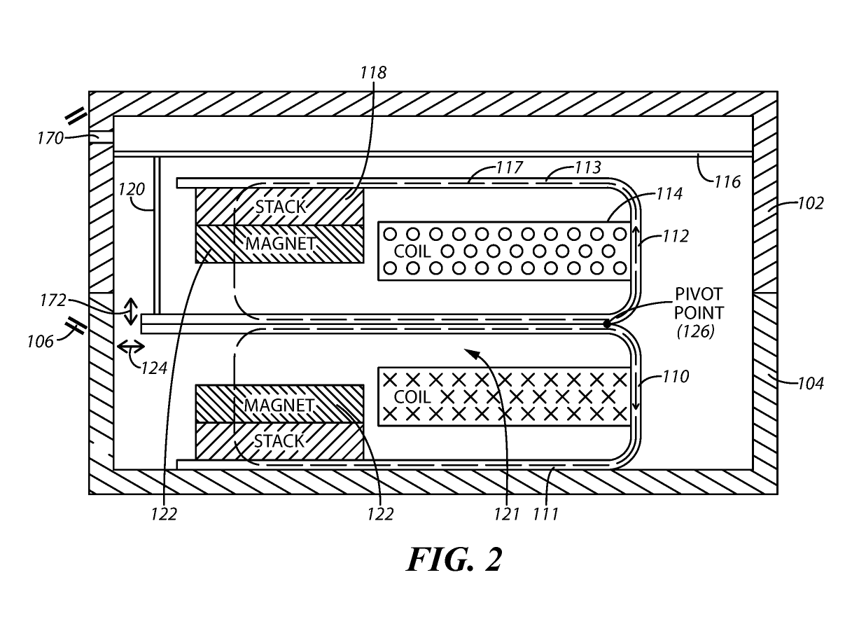

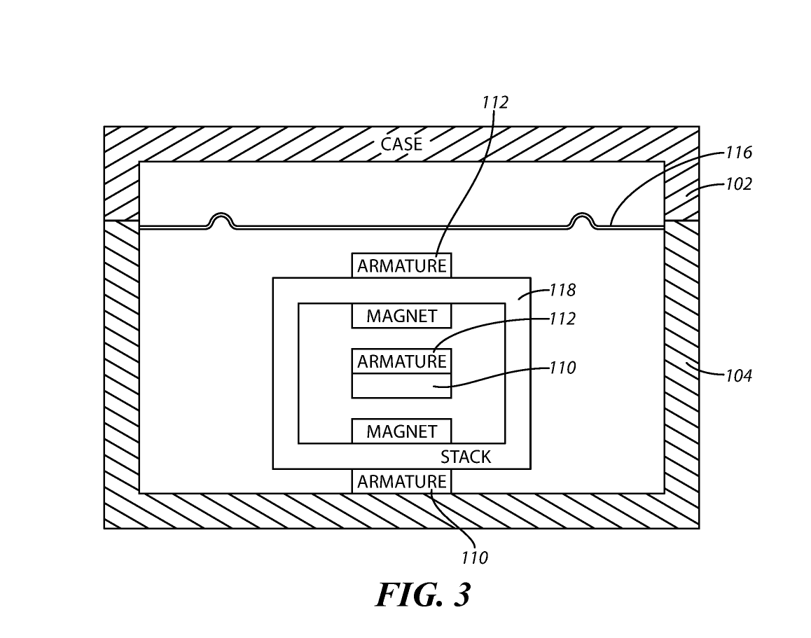

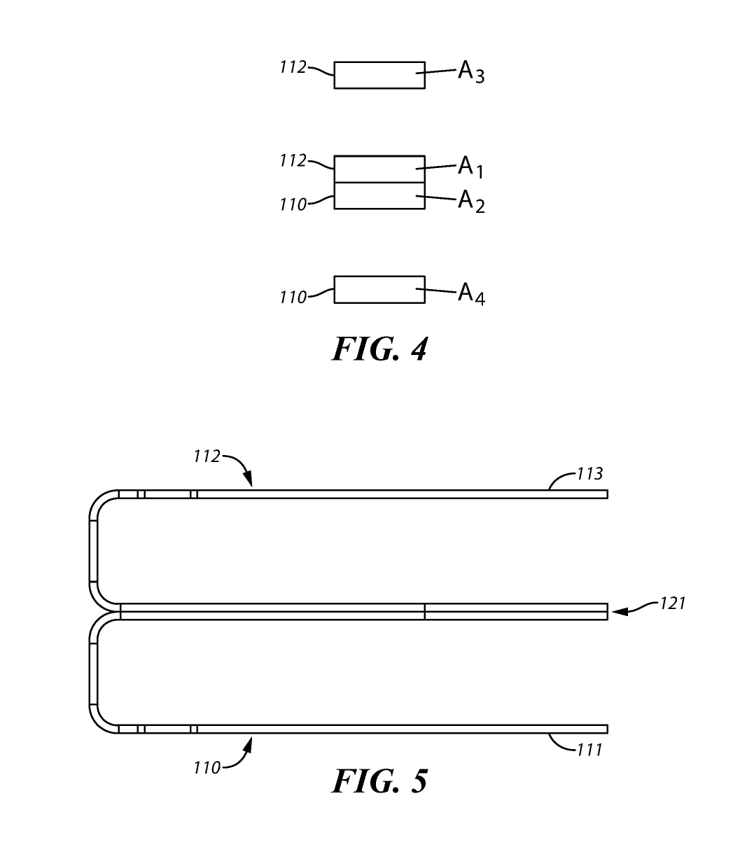

Referring now to FIGS. 1, 2, 3, 4, and 5, one example of a receiver 100 is described. The receiver 100 includes a top cup 102, a bottom cup 104, and a sound tube 106 with an opening 110. A receiver motor is positioned in the interior of the receiver 100. The motor includes a stack 118, magnets 122, a coil 114 and a first armature portion 110 (having a side arm or wing 111) and a second armature portion 112 (having a side arm or wing 113). A drive rod 122 is coupled to a diaphragm 116. Magnetic flux lines 117 may be produced during operation to effectively create a magnetic circuit.

Electrical current excites the coil 114 creating a magnetic flux 117 that moves reed 110, 112 in the direction indicated by the arrow labeled 122, but not in the direction indicated by the arrow labeled 124. More specifically, a central portion 121 if the armature moves while the wings 111 and 113 remain fixed with respect to the housing.

Movement of the armature 110, 112 moves the drive rod 120 thereby moving the diaphragm 116. Sound is produced and exits port 126 (through top cup 102). The sound traverses sound tube 106 and exits through opening 108.

The stack may be constructed of high permeability iron/nickel magnet material, for example. The reeds 110, 112, may also be constructed of an iron/nickel compound (in one example, the material is approximately 50% of each of these materials). The reeds 110, 112 may be laminated together or connected by alternate methods. In another example, they may be glued together. In still another example the reeds 110, 112 may be injection molded and formed together as a single piece. In one example and in the cross-section, each of the reeds is 0.005 inches thick and 0.090 inches wide. Other dimensions of the cross-section of the reeds 110, 112 are possible.

In other aspects, a thin insulation layer may be disposed between the reeds 110, 112 where the reeds 110, 112 contact (i.e., the central portion 121). In one advantage, the use of a layer of insulation may reduce the effects (or amounts) of eddy currents. In still other aspects, one of the reeds 110, 112 can be formed or constructed with very small bumps. Thus and in this approach, the two reeds 110, 112 may be separated by a small space because the bumps will not allow the two surfaces to be flush with each other.

A pivot point 126 exists in the central portion where the reeds 110, 112 meet. In one aspect, the pivot point is the same for each reed 110, 112. By pivot point and as used herein, it is meant that movement of the reeds 110, 112 rotates or turns about that point. Since the point is in the central portion of where the reeds 110, 112 meet, there can be no horizontal movement of the reeds 110, 112 in the direction indicated by the arrow labeled 124. In fact, movement of the reeds 110, 112 can only be movement in the direction indicated by the arrow labeled 122. It will be appreciated that the directions indicated by the arrows labeled 122 and 124 are orthogonal to each other. Movement of the reeds 110, 112 in the direction indicated by the arrow labeled 124 produces no sound and only produces negative effects (e.g., distortion) for the receiver 100. It will also be understood that the pivot point is not located in the arm 111 of reed 110 or the arm 113 of reed 112. If pivot points were located in these arms, then horizontal movement of the reeds 110, 112 would be possible and negative performance characteristics would occur.

The reed 110, 112 moves only or substantially in the direction indicated by the arrows labeled 122. The reed 110, 112 does not move or does not substantially move in the direction indicated by the arrows labeled 124.

Referring now especially to FIG. 5, in one aspect the cross sectional area of the reed in the central portion 121 is equal to the sum of the cross-sectional areas in the wing portions 111 and 113. For example, the cross sectional area of reed 110 in the central portion is A2, the cross sectional area of reed 112 in the central portion is A1, the cross sectional area of reed 110 in the wing portion is A4, and the cross sectional area of reed 112 in the central portion is A3. A1+A2=A3+A4. By maintaining this relationship, no throttling of the magnetic flux occurs and the magnetic circuit represented by the flux lines 117 in optimized.

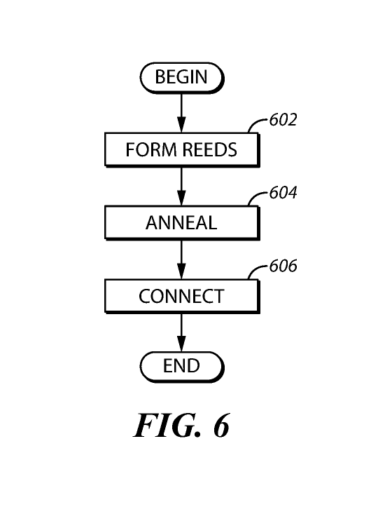

Referring now to FIG. 6, one example of an approach for manufacturing the armature (or reed) assembly and the receiver described herein is described. At step 602, the reeds (e.g., reeds 110, 112) are formed. They may be stamped from a sheet of material. They may be fabricated as individual units or in array. At step 604, the material is annealed to give it specific magnetic properties (e.g., magnetic permeability). At step 604, the two portions are secured together. For example, the two reeds may be glued together. Other attachment approaches can be used. Alternate attachments method may allow for forming of the reed before the annealing process.

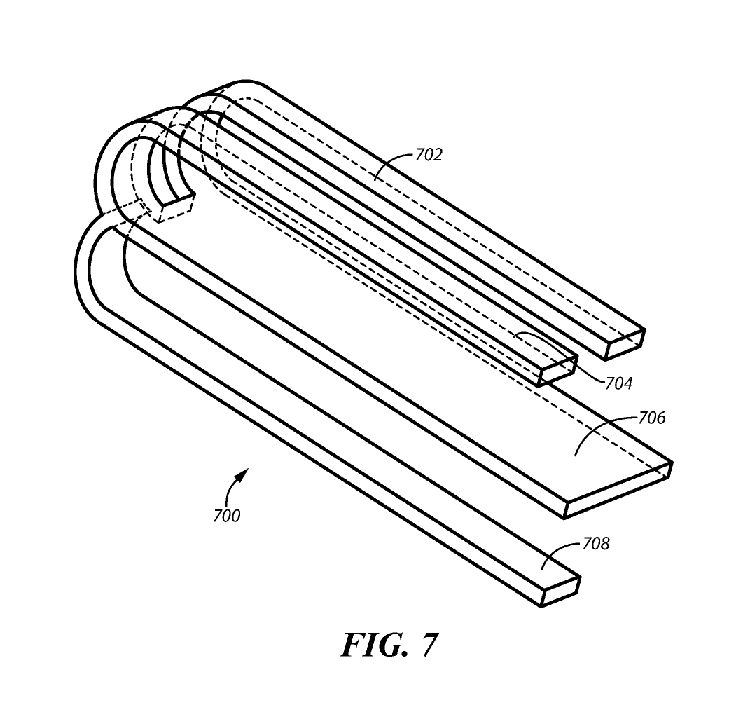

Referring now to FIG. 7, one example of another reed 700 used in the present approaches is described. In this example, the reed 700 is split at the top portion into a first top portion 702 and a second top portion 704. The splitting of the top portion into two sub-portions is advantageous because by attaching the reed to both top and bottom of the stack a reduction of reed axial motion is achieved. This axial motion is related to an unwanted axial vibration in receivers. As mentioned, this configuration allows attachment of the reed 700 to both the sides of the stack as described above. The reed 700 also includes a middle portion 706 and a bottom portion 708.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An apparatus comprising:
a first armature and a second armature, wherein the first armature and the second armature are coupled together in a common connection region;
a coil, wherein at least a portion of the common connection region extends through the coil, the coil extending around a horizontal axis;
one or more magnets supported by a magnetically permeable support structure;
a connector coupled to the common connection region; and
a diaphragm coupled to the connector;
wherein electrical excitation of the coil causes the common connection region to move in a vertical direction orthogonal to the horizontal axis and not along the horizontal axis.

2. The apparatus of claim 1, wherein the connector is s a drive rod.

3. The apparatus of claim 1, further comprising:
an insulation layer disposed between the first armature and the second armature.

4. The apparatus of claim 3, wherein the insulation layer extends along the common connection region.

5. The apparatus of claim 1, wherein one or more of the first armature and the second armature includes bumps.

6. The apparatus of claim 1, wherein the one or more magnets comprise a material with a low magnetic permeability compared to the magnetically permeable support structure.

7. The apparatus of claim 1, wherein one or more of the first armature and the second armature comprise an iron/nickel compound.

8. The apparatus of claim 1, wherein the first armature and the second armature are coupled via lamination.

9. The apparatus of claim 1, wherein the first armature and the second armature comprise a single structure.

10. The apparatus of claim 1, wherein the apparatus is disposed in a housing.
